(19) United States
(12) Patent Application Publication
(10) Pub. No.: US 2010/0329762 A1
(43) Pub. Date: Dec. 30, 2010

(54) IMAGE FORMING APPARATUS

(75) Inventor: Yoshitaka Yamazaki, Abiko-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/820,416

(22) Filed: Jun. 22, 2010

(30) Foreign Application Priority Data
Jun. 30, 2009 (JP) 2009-154464

(51) Int. Cl. G03G 15/00

(52) U.S. Cl. 399/401

(57) ABSTRACT

An image forming apparatus has a switch-back conveying portion to convey a sheet conveyed through either a first conveying path or a second conveying path as being switched-back, a mode in which a sheet passed through the first conveying path is conveyed to the second conveying path as being switched-back by the switch-back conveying portion and a mode in which a sheet passed through the second conveying path is conveyed to the first conveying path as being switched-back by the switch-back conveying portion are selectively performed.

### BACKGROUND OF THE INVENTION

1. Field of the Invention

The present invention relates to an image forming apparatus to form an image on a sheet.

2. Description of the Related Art

There has been an image forming apparatus including a sheet conveying apparatus which conveys a sheet with front-back reversing. The front-back reversing of a sheet is performed to print information on both faces of the sheet. Since sheet consumption against the information amount can be suppressed by forming an image respectively on both faces, the technology thereof is becoming more important recently also in view of environmental protection. The front-back reversing of a sheet is also performed to align page sequence of discharged sheets (i.e., the reverse discharging).

In order to reverse the front and back of a sheet, the sheet is conveyed as being switched-back and the sheet conveying direction is changed. For a reversing mechanism portion which performs such switch-back operation requires to ensure space on a conveying path for performing the switch-back operation. When space to switch-back a sheet for forming an image on both faces and space to switch-back a sheet for reverse discharging are arranged separately, the apparatus is to be upsized.

With an image forming apparatus, the front-back reversing is required to be quickly performed in order to enhance productivity. There has been an image forming apparatus to accelerate conveying speed of a sheet to be conveyed as being switched-back and enlarge an interval between a preceding sheet and a succeeding sheet (i.e., a sheet interval). Meanwhile, the following configuration has been proposed as a sheet reversing mechanism without performing sheet acceleration for enlarging a sheet interval. Japanese Patent Application Laid-Open No. 2004-331278 has proposed a configuration to separate a pair of rollers at a sheet reversing mechanism portion and to frictionally convey a preceding sheet and a succeeding sheet through the pair of separated rollers (i.e., separation control of a pair of rollers and frictional sheet conveyance).

With the configuration of performing the separation control of a pair of rollers, motor noise caused by roller acceleration is reduced since a sheet is less required to be accelerated. However, following problems occur. First, operational noise occurs at the time of separating and contacting of a pair of rollers. Further, frictional noise occurs when sheets are to be frictionally conveyed. Accordingly, operational noise as a whole product is increased. Recently, in an office where an image forming apparatus such as a multi-function copying machine and a printer is used, quietness of operational noise of other office electrical apparatuses has been actualized. Accordingly, quietness of similar level has been also required against copying machines. Therefore, it is not preferable that operational noise of an image forming apparatus is to be increased.

To address the above issues, the present invention provides a small image forming apparatus capable of performing reverse discharging and duplex printing.

### SUMMARY OF THE INVENTION

According to the invention, there is provided an image forming apparatus including: an image forming portion which forms an image on a sheet; a first conveying path and a second conveying path to which a sheet having an image formed by the image forming portion is conveyed and which are arranged in parallel; a guide portion which guides a sheet having an image formed by the image forming portion selectively to either the first conveying path or the second conveying path; a switch-back conveying portion which conveys a sheet conveyed through either the first conveying path or the second conveying path as being switched-back; and a control portion selectively performs a mode in which a sheet passed through the first conveying path is conveyed to the second conveying path as being switched-back by the switch-back conveying portion and a mode in which a sheet passed through the second conveying path is conveyed to the first conveying path as being switched-back by the switch-back conveying portion.

Further features of the present invention will become apparent from the following description of exemplary embodiments with reference to the attached drawings.

### BRIEF DESCRIPTION OF THE DRAWINGS

FIG. 1 is a view which illustrates a schematic configuration of an image forming apparatus according to an embodiment of the present invention;

FIG. 2 is a control block diagram of the image forming apparatus according to the embodiment of the present invention;

FIGS. 3A and 3B are views which illustrate a part of the image forming apparatus including a reversing mechanism portion for respectively indicating a first and a second processes of sheet conveying processes in a reverse discharge mode according to the embodiment of the present invention;

FIGS. 4A and 4B are views which indicate a third and a fourth processes of the same;

FIG. 5 is a view which indicates a fifth process of the same;

FIGS. 6A and 6B are views which illustrate a part of the image forming apparatus including a part of the reversing mechanism portion and a re-conveying portion for respectively indicating the first and second processes of the sheet conveying processes in a duplex printing mode according to the embodiment of the present invention;

FIGS. 7A and 7B are views which indicate the third and fourth processes of the same;

FIG. 8 is a view which indicates the fifth process of the same; and

FIGS. 9A and 9B are views which indicate a sixth and a seventh process of the same.

### DESCRIPTION OF THE EMBODIMENTS

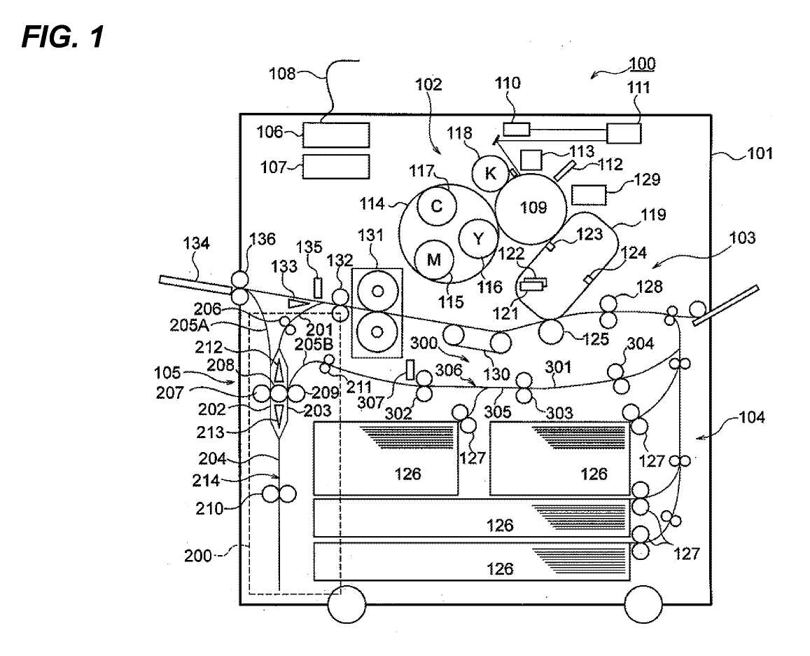

In the following, embodiments of the present invention will be described with reference to the drawings. FIG. 1 is a view illustrating the configuration of a full-color laser beam printer as an example of an image forming apparatus including a sheet conveying apparatus according to the present embodiment.

A color image forming apparatus 100 and a color image forming apparatus main body (hereinafter, called the apparatus main body) 101 are illustrated in FIG. 1. The apparatus main body 101 is provided with an image forming portion 102, a transfer portion 103 which transfers a toner image formed at the image forming portion 102 to a sheet, a sheet feed portion 104 which conveys a sheet and a sheet conveying portion 105 being a sheet conveying apparatus to convey an image-formed sheet.

The color image forming apparatus 100 is controlled by a controller 106 and a controlling portion 107 and performs printing. Here, the controller 106 sends, to the color image forming apparatus 100, a print control command for an image from an image reader (not illustrated) and an image expanded from data of a page-description language (PDL) transmitted from a host computer or an image input apparatus via a cable 108. Then, the controlling portion 107 performs printing by controlling respective structural elements of the color image forming apparatus 100 which are described in the following.

The image forming portion 102 includes a photosensitive drum 109, a laser unit 110, a polygon mirror 111, a pre-exposure apparatus 112, a primary charger 113 and a rotational development device 114. Here, the laser unit 110 is to irradiate light for exposure to form a latent image. The polygon mirror 111 is to perform scanning with laser light irradiated from the laser unit 110. The pre-exposure apparatus 112 is to eliminate excessive charges from the photosensitive drum 109. The primary charger 113 is to charge the photosensitive drum 109. The photosensitive drum 109 charged by the primary charger 113 is exposed by laser light modulated by the laser unit 110, so that an electrostatic latent image is formed on the photosensitive drum 109.

The rotational development device 114 incorporates an M-development device 115 to perform development of magenta, a Y-development device 116 to perform development of yellow and a C-development device 117 to perform development of cyan. Then, the rotational development device 114 is rotated by a motor (not illustrated) to selectively put the respective development devices 115 to 117 to be close to the photosensitive drum 109 in accordance with each decomposed color. A K-development device 118 performs development of black. The electrostatic latent image on the photosensitive drum 109 is respectively developed by each of the development devices 115 to 118 and is primarily transferred to an intermediate transfer belt (ITB) 119 constituting the transfer portion 103 with predetermined pressing force and electrostatic loading bias. Residual toner on the photosensitive drum 109 after the primary transfer is eliminated by a cleaner 129.

Here, colors for forming an image are not limited to the four colors and alignment sequence of colors is not limited to the above, as well. Further, the method of transferring a toner image to a sheet is not limited to the abovementioned method. For example, it is also possible to adopt a direct transfer method in which a toner image is transferred directly to a sheet not via a transfer belt. Further, it is also possible to adopt a tandem method in which respective development devices are aligned along the intermediate transfer belt 119 without utilizing the rotational development device 114.

Further, a home-position sensor of the intermediate transfer belt 119 (i.e., an ITB-HP sensor) 121, 122 is placed one each at the front side and the back side against the paper face of FIG. 1 at the same position viewing in the driving direction of the intermediate transfer belt 119 (i.e., in the ITB circumferential direction). In addition, a flag 123, 124 for the ITB-HP sensor is placed one each at the front side and the back side against the paper face of FIG. 1 at positions being mutually point symmetry viewing in the ITB circumferential direction. The home-position sensor 121 generates an HP signal when an edge of the flag 123 is detected. The home-position sensor 122 generates a HP signal when an edge of the flag 124 is detected. Primary transfer of a toner image of each color to the intermediate transfer belt 119 is performed in synchronization with either of the HP signals. When toner images of four colors are superimposed on the intermediate transfer belt 119 by the primary transfer, the non-fixed image is absorbed to a sheet (i.e., the image is secondarily transferred) by applying predetermined pressing force and electrostatic load bias with a secondary transfer roller 125 therebetween.

The sheet feed portion 104 includes a plurality of sheet storage portions 126, 126 to store sheets and pairs of sheet feed rollers 127, 127 to feed a sheet stored in the sheet storage portion 126. Skew feeding of a sheet fed from the sheet feed portion 104 is corrected by being struck to a pair of registration rollers 128 which is not moving. Then, registration alignment is performed by driving the pair of registration rollers 128 corresponding to timing of image forming. That is, the pair of registration rollers 128 is driven corresponding to the timing of image forming to the intermediate transfer belt 119, so that the sheet and the image on the intermediate transfer belt 119 arrive at the secondary transfer roller 125 being mutually synchronized. Then, the image is secondarily transferred to a predetermined position of the sheet. The sheet having the secondary transfer performed is conveyed toward a fixing device 131 by a conveying belt 130. At the fixing device 131, toner is melted and fixed on the sheet by applying predetermined pressing force with an approximately opposing roller or belt and by applying heating effect with a heat source such as a heater in general.

The sheet having a fixed image as described above is conveyed to a branch switching unit 133 by a pair of inward discharge rollers 132. Then, the conveying direction of the sheet is switched by the branch switching unit 133. In the case that the sheet having an image formed only at one face (i.e., the first face) thereof is to be discharged without being reversed, the sheet is simply discharged onto a discharge tray 134. Meanwhile, in the case that an image is to be formed on the second face being the back face of the sheet or that the sheet is to be discharged as being reversed (i.e., as the printed face being the lower face, that is, being faced-down), the sheet is conveyed to a reversing mechanism portion 200 constituting the sheet conveying portion 105 by the switching of the branch switching unit 133.

Here, a reverse sensor 135 detects timing to convey the sheet to the reversing mechanism portion 200. The pair of inward discharge rollers 132 is driven by a driving source same as that for the fixing device 131 and conveys the sheet from the fixing device 131 toward the branch switching unit 133. Further, the pair of inward discharge rollers 132 incorporates an one-way clutch to run idle when the sheet conveying speed is higher than the drive speed of the pairs of inward discharge rollers 132. A pair of outward discharge rollers 136 discharges the sheet conveyed without being reversed or the sheet reversed by the reversing mechanism portion 200 onto the externally arranged discharge tray 134. The pair of outward discharge rollers 136 corresponds to a reverse discharge portion.

The reversing mechanism portion 200 includes plural conveying paths, plural pairs of rollers and plural rollers, and a pair of switching unit. Specifically, a reverse inlet conveying path (i.e., an upstream conveying path) 201, a first conveying path 202 and a second conveying path 203, a reverse conveying path 204, and reverse outlet conveying paths 205A, 205B are arranged respectively in the order from the upstream side of the sheet conveying direction. Here, the first conveying path 202 and the second conveying path 203 are arranged mutually in parallel. Further, the pair of outward discharge rollers 136 to discharge a reversed sheet is arranged at the downstream side of the reverse outlet conveying path 205A of the reverse discharge portion side. Meanwhile, a re-conveying portion 300 to convey a reversed sheet to the image forming portion anew in order to form an image on the second face of the sheet is arranged at the downstream side of the reverse outlet conveying path (i.e., a downstream conveying path) 205B of the re-conveying portion side.

Further, a pair of reverse inlet rollers 206 is arranged at the reverse inlet conveying path 201. First to third rollers 207, 208, 209 are arranged at the first conveying path 202 and the second conveying path 203. A pair of reversing rollers 210 is arranged at the reverse conveying path 204. A pair of re-conveying rollers 211 is arranged at the reverse outlet conveying path 205B.

Further, an inlet side switching unit 212 to switch the sheet conveying direction in accordance with a later-mentioned sheet conveyance mode is arranged between the reverse inlet conveying path 201 and the first and second conveying paths 202, 203. The inlet side switching unit 212 as a guide portion guides a sheet passing through the reverse inlet conveying path 201 to either the first conveying path 202 or the second conveying path 203. Further, a reverse side switching unit 213 to switch the sheet conveying direction in accordance with the sheet conveyance mode is arranged between the first and second conveying paths 202, 203 and the reverse conveying path 204. The reverse side switching unit 213 as a second guide portion guides a sheet conveyed as being switched-back by the pair of reversing rollers 210 to either the first conveying path 202 or the second conveying path 203.

The pair of reverse inlet rollers 206, the first to third rollers 207, 208, 209, and the pair of re-conveying rollers 211 are rotated as being mutually synchronized by the same driving source (for example, by a motor). At least one roller among the first to third rollers 207, 208, 209 is only required to be driven. For example, the second roller 208 arranged at the center is to be driven. Provided that any one of the rollers is driven as described above, a sheet is possible to be conveyed respectively between the first roller 207 and the second roller 208 and between the second roller 208 and the third roller 209. Meanwhile, the pair of reversing rollers 210 is to be separately driven by a driving source being different from that for the abovementioned respective pairs of rollers and respective rollers. The inlet side switching unit 212 and the reverse side switching unit 213 are to be driven being mutually synchronized by the same driving source (for example, by a solenoid valve).

By switching the branch switching unit 133, the sheet conveyed to the reversing mechanism portion 200 is conveyed to the reverse inlet conveying path 201 by the pair of reverse inlet rollers 206. At that time, the pair of reverse inlet rollers 206 is driven to be faster than the pair of inward discharge rollers 132 so as to drag the sheet in a state that the sheet conveying speed is accelerated. As described above, even in the case that the sheet conveying speed is accelerated by the pair of reverse inlet rollers 206, the pair of inward discharge rollers 132 runs idle while supporting the later part of the sheet and allows the sheet conveying speed to be accelerated since the one-way clutch is incorporated thereto.

Next, by switching the inlet side switching unit 212, the sheet is conveyed to the first conveying path 202 or the second conveying path 203. At that time, the sheet is conveyed by the first roller 207 and the second roller 208 or by the second roller 208 and the third roller 209. The sheet passing through the first conveying path 202 or the second conveying path 203 as described above is conveyed to the reverse conveying path 204 and the rear end of the sheet arrives at a reverse stop position 214.

Subsequently, the sheet is conveyed as being switched-back by driving the pair of reversing rollers 210 so that the relation between the top end and rear end of the sheet is reversed. Then, the conveyed sheet as being switched-back is conveyed to the first conveying path 202 or the second conveying path 203 by switching the position of the reverse side switching unit 213. Thereafter, the sheet passing through the first conveying path 202 or the second conveying path 203 is conveyed to either of the reverse outlet conveying paths 205A, 205B.

As described above, in the present embodiment, two reverse outlet conveying paths are provided and are connected respectively to the reverse discharge portion and the re-conveying portion 300. Accordingly, two types of sheet conveyance modes, that is, a reverse discharge mode to discharge a sheet after reversing and a duplex printing mode to form an image on the second face of a sheet, are possible to be selected. When the reverse discharge mode is selected, the reversed sheet is conveyed to the reverse outlet conveying path 205A via the first conveying path 202, and then, discharged on the discharge tray 134 by the pair of outward discharge rollers 136.

Meanwhile, when the duplex printing mode is selected, the conveyed sheet as being switched-back is conveyed to the reverse outlet conveying path 205B via the second conveying path 203 and conveyed to the re-conveying portion 300 by the pair of re-conveying rollers 211. The present embodiment is applicable to an image forming apparatus such as a printer having at least either the abovementioned reverse discharge mode or duplex printing mode.

The re-conveying portion 300 is configured to arrange a pair of upstream rollers 302, a pair of intermediate rollers 303 and a pair of downstream rollers 304 to a re-conveying path 301. A merging point 305 where a sheet fed from a sheet storage portion 126 located at the left side in FIG. 1 is merged is formed at some midpoint of the re-conveying path 301. The sheet conveyed to the re-conveying portion 300 is conveyed until the top end thereof arrives at a re-feed standby position 306 by the pair of upstream rollers 302. The timing to stop the sheet at the re-feed standby position 306 is controlled by a standby sensor 307 arranged at the re-conveying path 301.

The sheet on standby at the re-feed standby position 306 is conveyed by driving the pair of upstream rollers 302, for example, after a sheet fed from the sheet storage portion 126 at the left side in FIG. 1 passes through the merging point 305 and is conveyed to a predetermined position. Then, the sheet is conveyed to the image forming portion by driving the pair of intermediate rollers 303 and the pair of downstream rollers 304.

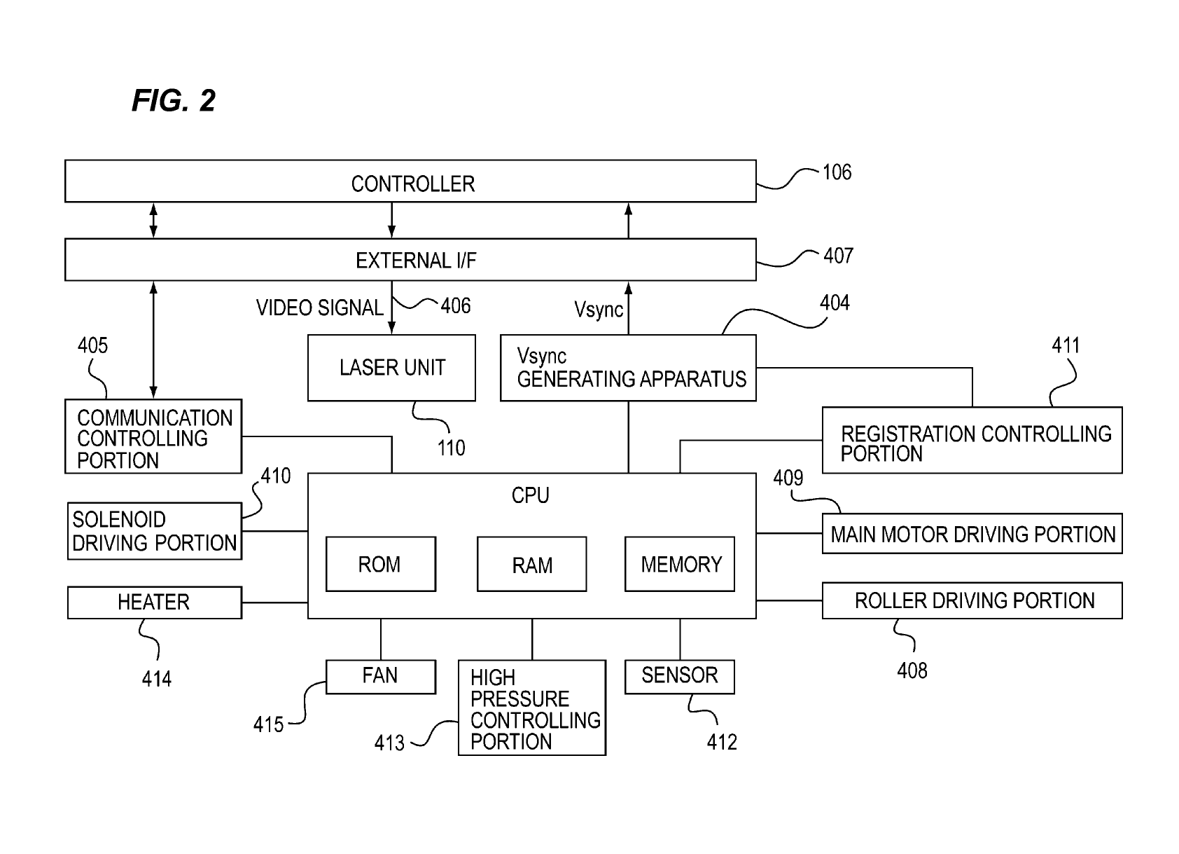

FIG. 2 is a control block diagram of the color image forming apparatus 100 according to the present embodiment. A CPU 400 to perform controlling of the entire color image forming apparatus 100 includes a ROM 401, a RAM 402 and a non-volatile memory 403. Here, the ROM 401 stores a control program. The RAM 402 is utilized for a work area in the control. The non-volatile memory 403 stores diverse adjustment values. The abovementioned CPU 400 controls diverse devices described in the following.

Among the diverse devices, a Vsync generating apparatus 404 is utilized for synchronizing image signals between the CPU 400 and an external device such as an image input apparatus. A communication controlling portion 405 manages command communication with the external device. Image data synchronized by the Vsync generating apparatus 404 is transmitted from the external device to the laser unit 110 via a video signal line 406. The laser unit 110 performs exposure by modulating the received image data. Such sending and receiving of data and communication is performed with the controller 106 illustrated also in FIG. 1 via an external interface (I/F) 407.

Further, a roller driving portion 408 controls conveying load of a motor to drive diverse rollers. For example, the roller driving portion 408 controls a motor to drive the pair of inward discharge rollers 132 and the fixing device 131, a motor to drive the first to third rollers 207, 208, 209, the pair of reverse inlet rollers 206 and the pair of re-conveying rollers 210, and a motor to drive the pair of outward discharge rollers 136.

Here, a motor to drive the intermediate transfer belt 119 and the photosensitive drum 109 is controlled by a main motor driving portion 409. A solenoid driving portion 410 controls a solenoid to drive the inlet side switching unit 212 and the reverse side switching unit 213 which are arranged at the reversing mechanism portion 200 and a solenoid to drive the branch switching unit 133. A registration controlling portion 411 generates a registration ON-signal in synchronization with the main motor driving portion 409 and drives the pair of registration rollers 128. Accordingly, a toner image is transferred to a predetermined position of a sheet.

Diverse sensors 412 detect sheet conveyance situations, circumstances and the like. The reverse sensor 135 and the standby sensor 307 are examples thereof. Here, the signal output from a sensor such as the reverse sensor 135 to detect sheet conveyance situations is to be validated only during a predetermined period at the timing when a sheet is scheduled to pass not to be continuously monitored by the CPU 400. In this manner, the CPU 400 can accurately detect the end part of a sheet by the sensor. A high pressure controlling portion 413 performs diverse high pressure controls in a print process. A heater 414 is for the fixing device 131 and the like. Diverse fans 415 are arranged in the color image forming apparatus 100.

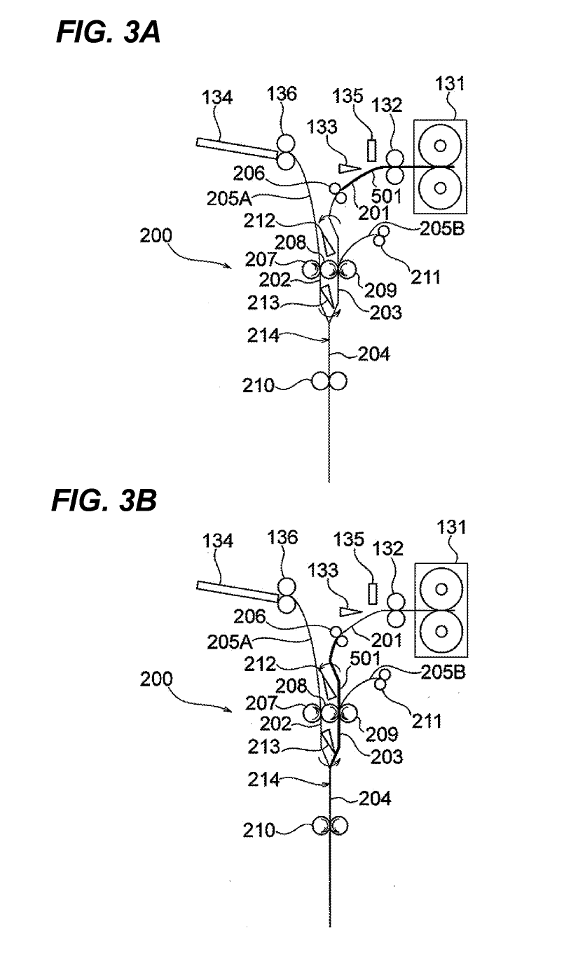

In the following, the sheet conveyance of the reverse discharge mode and the duplex printing mode according to the present embodiment will be described with reference to FIGS. 3 to 9. In FIGS. 3 to 9, the same numeral is given to the same member as in FIG. 1. Further, in FIGS. 3 to 9, a preceding sheet 501 is precedingly conveyed to the reversing mechanism portion 200 and a succeeding sheet 502 is succeedingly conveyed thereto.

First, the sheet conveyance in the reverse discharge mode is described with reference to FIGS. 3 to 5. In FIG. 3A, the preceding sheet 501 having an image formed on the first face thereof is closing to the reversing mechanism portion 200. At the same time, the pair of reverse inlet rollers 206 located at the reverse inlet conveying path 201 is rotated at the same speed as that of the pair of inward discharge rollers 132. Further, the first to third rollers 207, 208, 209 constituting the first conveying path 202 and the second conveying path 203 are rotated at the same speed as that of the pair of reverse inlet rollers 206. Here, the second roller 208 is rotated in the clockwise direction (i.e., the direction of an arrow) in FIGS. 3 to 5. The first roller 207 and the third roller 209 are rotated in the counterclockwise direction (i.e., the direction of arrows) in FIGS. 3 to 5. The rotation directions of the first to third rollers 207, 208, 209 are kept constant over the entire process of the reverse discharge mode. Accordingly, in the entire process of the reverse discharge mode, the first conveying path 202 conveys a sheet toward the reverse outlet conveying path 205A and the second conveying path 203 conveys a sheet toward the reverse conveying path 204. Further, the inlet side switching unit 212 and the reverse side switching unit 213 are inclined to the counterclockwise direction (i.e., the direction of arrows) in FIGS. 3 to 5. The inclination directions are kept constant as well over the entire process of the reverse discharge mode.

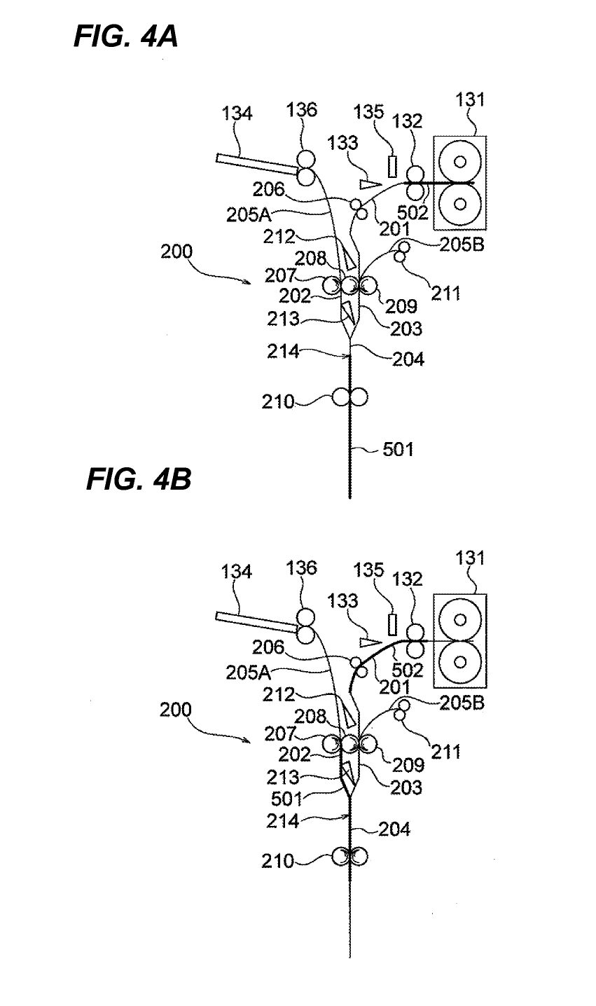

Next, the preceding sheet 501 is dragged into the reversing mechanism portion 200 by the pair of reverse inlet rollers 206. Then, the preceding sheet 501 is conveyed toward the second conveying path 203 being the other conveying path in the reverse discharge mode in accordance with inclination of the inlet side switching unit 212. That is, the inlet side switching unit 212 is previously moved to the position to guide a sheet to the second conveying path 203. After the rear end of the preceding sheet 501 passes through the fixing device 131, the preceding sheet 501 is conveyed to be the state of FIG. 3B by the second roller 208 and the third roller 209. At the same time, the pair of reversing rollers 210 is rotated in the normal rotational direction (i.e., the direction to drag a sheet being the direction of arrows). The motor to drive the pair of reverse rollers 210 is controlled by a timer for a stop event being set referring to the time when the reverse sensor 135 detects the top end of the preceding sheet 501. That is, as illustrated in FIG. 4A, the motor is controlled to stop at the time when the rear end of the preceding sheet 501 arrives at the reverse stop position 214 based on the conveying speed and the length in the conveying direction (i.e., the sheet length) of the preceding sheet 501.

The preceding sheet 501 is conveyed to the reverse conveying path 204 from the second conveying path 203 and dragged by the pair of reversing rollers 210. Then, as illustrated in FIG. 4A, the preceding sheet 501 is stopped when the rear end thereof arrives at the reverse stop position 214. In this state, the top end of the succeeding sheet 502 is closing to the reversing mechanism portion 200 exceeding the pair of inward discharge rollers 132.

Subsequently, the pair of reversing rollers 210 starts to be reversed (i.e., reverse rotation) in the direction of arrows in FIG. 4B. Accordingly, the preceding sheet 501 is conveyed as being switched-back to the first conveying path 202 as one conveying path in the reverse discharge mode by the reverse side switching unit 213 in the state that the top end and rear end thereof are switched. At that time, the reverse side switching unit 213 allows the preceding sheet 501 to be conveyed to the first conveying path 202. That is, the reverse side switching unit 213 is previously moved to the position to guide the sheet conveyed as being switched-back by the pair of reversing rollers 210 to the first conveying path 202. Then, as illustrated in FIG. 4B, the preceding sheet 501 is dragged between the first roller 207 and the second roller 208. At that time, the succeeding sheet 502 is dragged to the pair of reverse inlet rollers 206 and the top end thereof arrives at the branching point of the first conveying path 202 and the second conveying path 203.

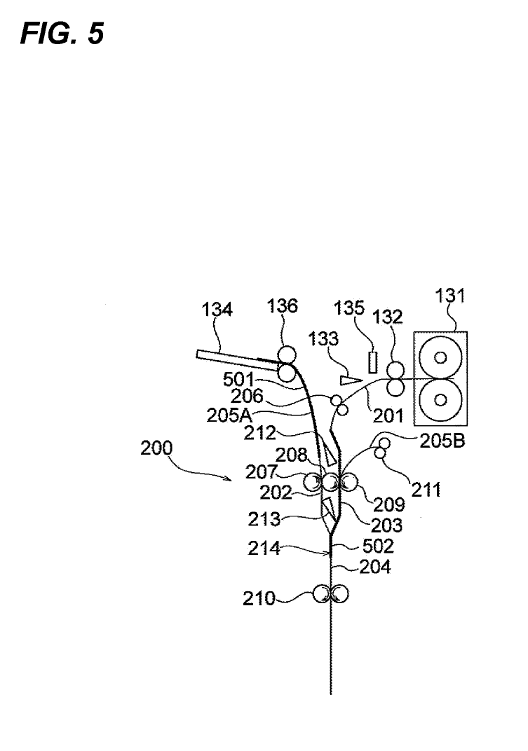

Next, as illustrated in FIG. 5, the preceding sheet 501 is conveyed to the reverse outlet conveying path 205A in the reversed state from the first conveying path 202 by the inlet side switching unit 212 and discharged to the outside of the apparatus by the pair of outward discharge rollers 136 as the discharge portion. Meanwhile, the succeeding sheet 502 is conveyed to the second conveying path 203 by the inlet side switching unit 212 and is dragged by the second roller 208 and the third roller 209. At the time when the rear end of the preceding sheet 501 passes through the pair of reversing rollers 210 and the rear end of the succeeding sheet 502 passes through the reverse sensor 135, the pair of reversing rollers 210 restarts to be driven in the normal rotation in the direction of arrows in FIG. 5. Similar to the preceding sheet 501 as illustrated in FIG. 4A, the succeeding sheet 502 is conveyed to the reverse conveying path 204, and then, a next preceding sheet is to be closed to the reversing mechanism portion 200. Subsequently, sheets are continuously conveyed to repeat from the state of FIG. 3 to the state of FIG. 5. In this manner, when the reverse discharge mode is utilized in the present embodiment, the preceding sheet 501 and the succeeding sheet 502 are passed each other at the first conveying path 202 and the second conveying path 203.

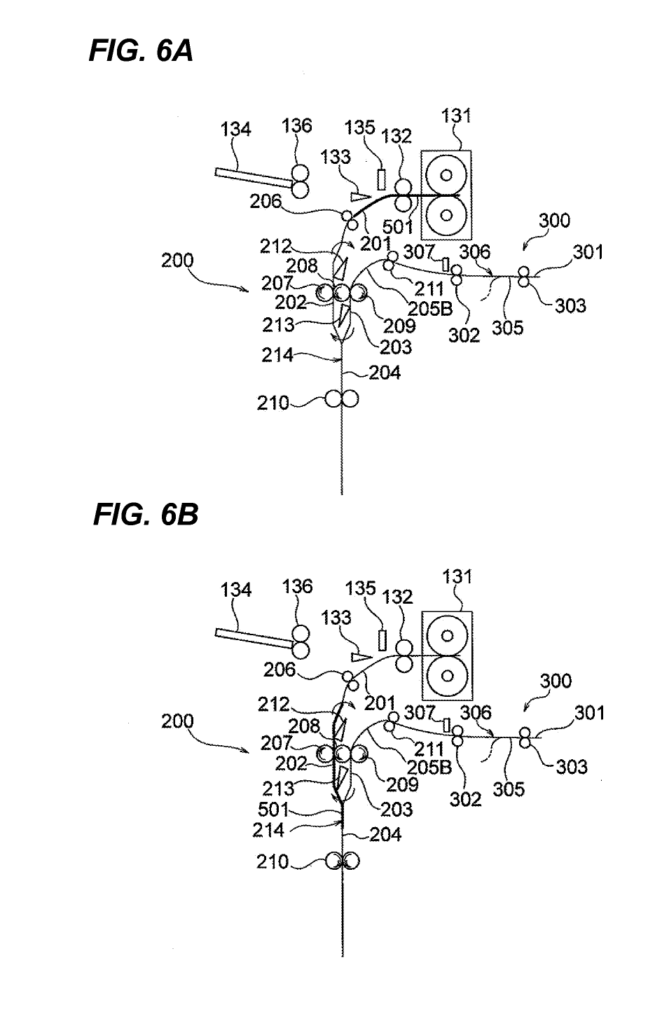

Next, the sheet conveyance in the duplex printing mode is described with reference to FIGS. 6 to 9. In FIG. 6A, the preceding sheet 501 having an image formed on the first face thereof is closing to the reversing mechanism portion 200. At the same time, the pair of reverse inlet rollers 206 located at the reverse inlet conveying path 201 is rotated at the same speed as that of the pair of inward discharge rollers 132. Further, the first to third rollers 207, 208, 209 constituting the first conveying path 202 and the second conveying path 203 are rotated at the same speed as that of the pair of reverse inlet rollers 206. Here, the second roller 208 is rotated in the counterclockwise direction (i.e., the direction of an arrow) in FIGS. 6 to 9. The first roller 207 and the third roller 209 are rotated in the clockwise direction (i.e., the direction of arrows) in FIGS. 6 to 9. The rotation directions of the first to third rollers 207, 208, 209 are kept constant over the entire process of the duplex printing mode. Accordingly, in the entire process of the duplex printing mode, the first conveying path 202 conveys a sheet toward the reverse conveying path 204 and the second conveying path 203 conveys a sheet toward the reverse outlet conveying path 205B. Further, the inlet side switching unit 212 and the reverse side switching unit 213 are inclined to the clockwise direction (i.e., the direction of arrows) in FIGS. 6 to 9. The inclination directions are kept constant as well over the entire process of the duplex printing mode.

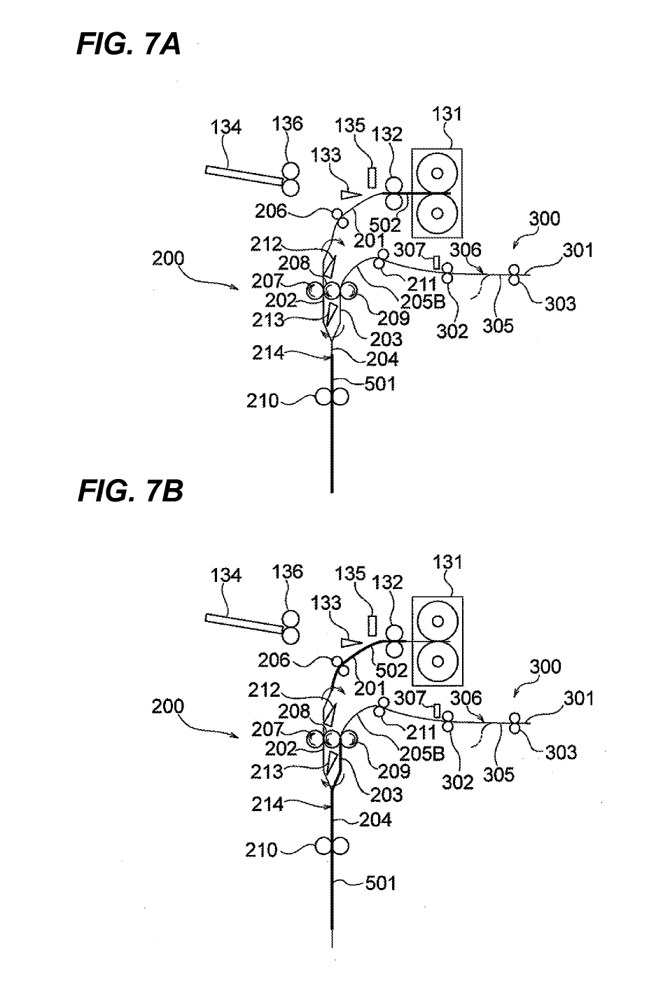

Next, the preceding sheet 501 is dragged into the reversing mechanism portion 200 by the pair of reverse inlet rollers 206. Then, the preceding sheet 501 is conveyed toward the first conveying path 202 being the other conveying path in the duplex printing mode in accordance with inclination of the inlet side switching unit 212. That is, the inlet side switching unit 212 is previously moved to the position to guide a sheet to the first conveying path 202. After the rear end of the preceding sheet 501 passes through the fixing device 131, the preceding sheet 501 is conveyed to be the state of FIG. 6B by the first roller 207 and the second roller 208. At the same time, the pair of reversing rollers 210 is rotated in the normal rotational direction (i.e., the direction to drag a sheet being the direction of arrows). The motor to drive the pair of reverse rollers 210 is controlled by the timer for a stop event being set referring to the time when the reverse sensor 135 detects the top end of the preceding sheet 501. That is, as illustrated in FIG. 7A, the motor is controlled to stop at the time when the rear end of the preceding sheet 501 arrives at the reverse stop position 214 based on the conveying speed and the length in the conveying direction (i.e., the sheet length) of the preceding sheet 501.

The preceding sheet 501 is conveyed to the reverse conveying path 204 from the first conveying path 202 and dragged by the pair of reversing rollers 210. Then, as illustrated in FIG. 7A, the preceding sheet 501 is stopped when the rear end thereof arrives at the reverse stop position 214. In this state, the top end of the succeeding sheet 502 is closing to the reversing mechanism portion 200 exceeding the pair of inward discharge rollers 132.

Subsequently, the pair of reversing rollers 210 starts to be reversed (i.e., reverse rotation) in the direction of arrows in FIG. 7B. Accordingly, the preceding sheet 501 is conveyed as being switched-back to the second conveying path 203 as one conveying path in the duplex printing mode by the reverse side switching unit 213 in the state that the top end and rear end thereof are switched. At that time, the reverse side switching unit 213 allows the preceding sheet 501 to be conveyed to the second conveying path 203. That is, the reverse side switching unit 213 is previously moved to the position to guide the sheet conveyed as being switched-back by the pair of reversing rollers 210 to the second conveying path 203. Then, as illustrated in FIG. 7B, the preceding sheet 501 is dragged between the second roller 208 and the third roller 209. At that time, the succeeding sheet 502 is dragged to the pair of reverse inlet rollers 206 and the top end thereof arrives at the branching point of the first conveying path 202 and the second conveying path 203.

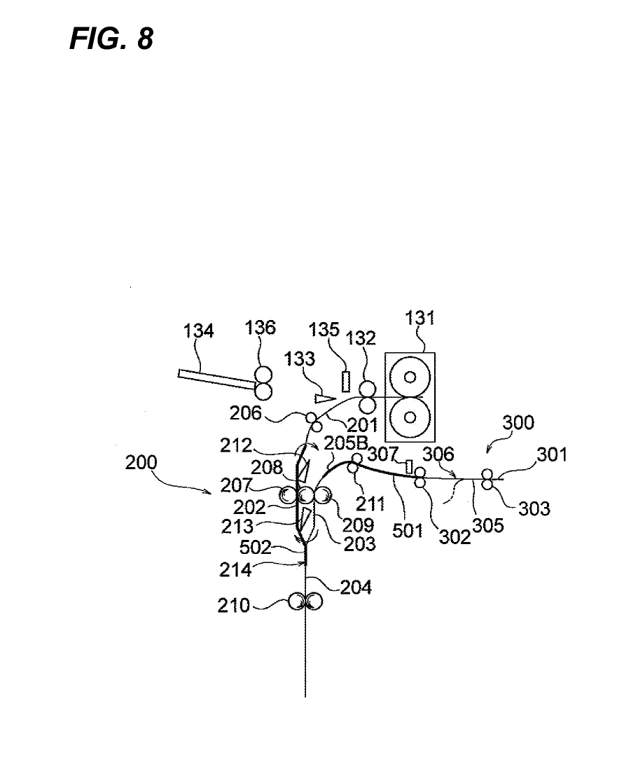

Next, as illustrated in FIG. 8, the preceding sheet 501 is conveyed to the reverse outlet conveying path 205B in the reversed state from the second conveying path 203 by the inlet side switching unit 212 and conveyed to the re-conveying portion 300 by the pair of re-conveying rollers 211. Meanwhile, the succeeding sheet 502 is conveyed to the first conveying path 202 by the inlet side switching unit 212 and is dragged by the first roller 207 and the second roller 208. At the time when the rear end of the preceding sheet 501 passes through the pair of reversing rollers 210 and the rear end of the succeeding sheet 502 passes through the reverse sensor 135, the pair of reversing rollers 210 restarts to be driven in the normal rotation in the direction of arrows in FIG. 8.

Subsequently, the preceding sheet 501 is detected by the standby sensor 307 of the re-conveying portion 300 and is conveyed toward the re-feed standby position 306 by the pair of upstream rollers 302. Meanwhile, the succeeding sheet 502 is conveyed to the reverse conveying path 204 via the first conveying path 202. The succeeding sheet 502 in FIG. 8 is to be in the same state of the preceding sheet 501 in FIG. 6B.

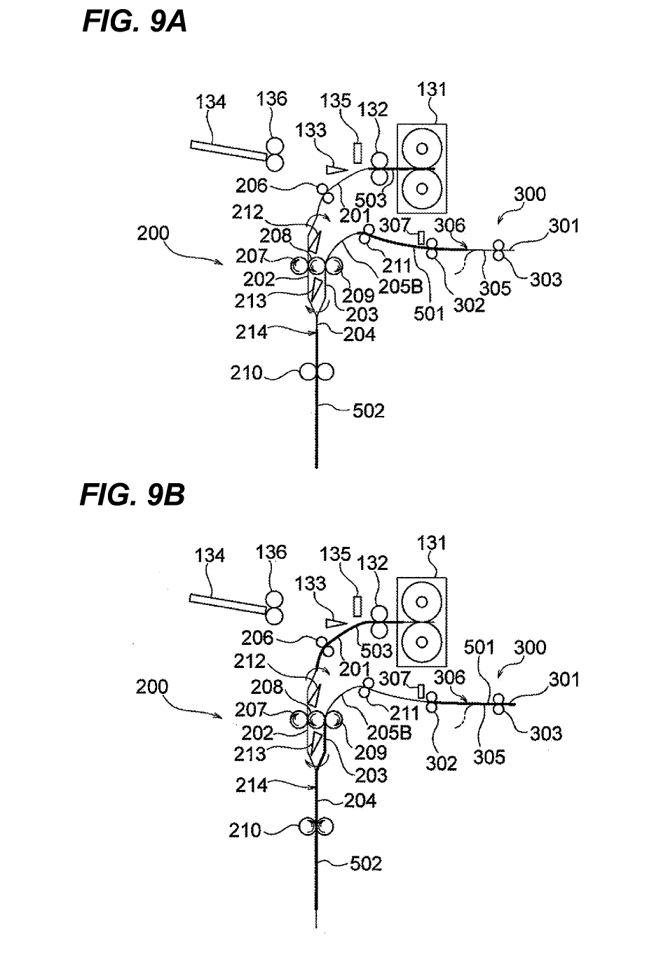

Next, as illustrated in FIG. 9A, the preceding sheet 501 is stopped in a state that the top end thereof arrived at the re-feed standby position 306 and the succeeding sheet 502 is stopped in a state that the rear end thereof arrived at the reverse stop position 214. Accordingly, two sheets having the first face printed are to be on standby. At that time, the next succeeding sheet 503 is closing to the reversing mechanism portion 200. Here, the relation between the succeeding sheet 502 and the next succeeding sheet 503 is to be the same as the relation between the preceding sheet 501 and the succeeding sheet 502 as illustrated in FIG. 7A.

Thereafter, the preceding sheet 501 on standby at the re-feed standby position 306 is conveyed by driving the pair of upstream rollers 302 after a sheet fed from the sheet storage portion 126 at the left side in FIG. 1 passes through the merging point 305 and is conveyed to a predetermined position. Then, as illustrated in FIG. 9B, the preceding sheet 501 is conveyed toward the image forming portion by driving the pair of intermediate rollers 303 (also, the pair of downstream rollers 304 in FIG. 1)

Meanwhile, the succeeding sheet 502 is conveyed to the second conveying path 203 by the reverse side switching unit 213 and the next preceding sheet 503 is conveyed to the branching point of the first conveying path 202 and the second conveying path 203. Here, the relation between the succeeding sheet 502 and the next succeeding sheet 503 is to be the same as the relation between the preceding sheet 501 and the succeeding sheet 502 as illustrated in FIG. 7B.

Then, the succeeding sheet 502 and the next succeeding sheet 503 proceed from the state of FIG. 8 to the state of FIG. 9. Subsequently, sheets are continuously conveyed to repeat from the state of FIG. 7 to the state of FIG. 9.

By the way, in the case of sheets being fully long (i.e., in the case of long sheets), the productivity for one face is inherently low, so that the interval between a preceding sheet and succeeding sheet is fully large. Accordingly, even in the case of through-pass duplex printing, the number of circulating sheets within the image forming apparatus is to be smaller than that of short sheets (i.e., small sheets). For example, five-sheet circulation (i.e., the number of circulating sheets is five) is performed with small sheets (for example, letter sheets) and three-sheet circulation is performed with long sheets (for example, 11×17 inches sheets). Accordingly, in most cases of long sheets, a preceding sheet and a succeeding sheet are fairly spaced for switch-back conveying.

In the case of middle-sized sheets (for example, letter-R sheets) sized between a small sheet and a long sheet, five-sheet circulation is required to perform full duplex productivity. Here, the full duplex productivity denotes performing a half number of print outputting in duplex printing compared to that of one face printing. Even with trying to perform five-sheet circulation to obtain the full duplex productivity with middle-sized sheets, there may be a case that five-sheet circulation cannot be performed due to an excessively small interval between a preceding sheet and a succeeding sheet. Accordingly, it may be required to control with three-sheet circulation being the same as the case of long sheets by expanding sheet intervals. Consequently, the problem that full duplex productivity cannot be obtained in duplex printing is apt to occur in the case of middle-sized sheets.

Meanwhile, even when the duplex printing mode is used in the present embodiment, the preceding sheet 501 and the succeeding sheet 502 are passed each other at the first conveying path 202 and the second conveying path 203. Accordingly, two-sheet standby of sheets having one face printed can be actualized in through-pass duplex printing. Therefore, for example, through-pass duplex printing can be performed in five-sheet circulation even with middle-sized sheets which are described in the following.

The sheet size in the present embodiment will be described in the following. In the present embodiment, the sheet size is classified into three categories in accordance with sheet length. The small sheet denotes a sheet of which length is shorter than a specific sheet length determined from the distance from the re-feed standby position 306 to the pair of re-conveying rollers 211. The large sheet denotes a sheet of which length is longer than a specific sheet length to be capable of performing through-pass duplex printing in three-sheet circulation. Then, the middle-sized sheet denotes a sheet of which length is between the small sheet and the large sheet.

In the present embodiment, the control of through-pass duplex printing by utilizing the first conveying path 202 and the second conveying path 203 as two reversing paths is performed in the case that the middle-sized sheets are conveyed. In the case of the small sheets, the small sheet conveyed through the reverse inlet conveying path 201 is guided to the first conveying path 202. Then, the small sheet is conveyed as being switched-back at the first conveying path 202 by the second roller 208, the third roller 209 and the pair of reversing rollers 210. Thereafter, the small sheet conveyed as being switched-back may be conveyed to the re-conveying portion 301 after passing through the reverse conveying path 205B. Naturally, even in the case of the small sheets, it is also possible to perform the control using the two reversing paths being similar to the case of the middle-sized sheets.

As described in the above, according to the present embodiment, even in the case of the middle-sized sheets, reverse discharge efficiency can be improved and duplex productivity can be fully obtained. Further, since roller separation control is not adopted and frictional sheet conveyance is not required, operational noise accompanied by conveying control thereof can be reduced compared to the related art. In addition, excellent productivity can be obtained in reverse discharging and duplex printing while controlling a driving source such as a motor to drive the pair of reverse inlet rollers 206, the first to third rollers 207 to 209 and the pair of re-conveying rollers 211 at constant speed in the same rotational direction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-154464, filed Jun. 30, 2009, which is hereby incorporated by reference herein in its entirety.

What is claimed is:

1. An image forming apparatus comprising:
an image forming portion which forms an image on a sheet;
a first conveying path and a second conveying path to which a sheet having an image formed by the image forming portion is conveyed and which are arranged in parallel;
a guide portion which guides a sheet having an image formed by the image forming portion selectively to either the first conveying path or the second conveying path;
a switch-back conveying portion which conveys a sheet conveyed through either the first conveying path or the second conveying path as being switched-back; and
a control portion selectively performs a mode in which a sheet passed through the first conveying path is conveyed to the second conveying path as being switched-back by the switch-back conveying portion and a mode in which a sheet passed through the second conveying path is conveyed to the first conveying path as being switched-back by the switch-back conveying portion.

2. The image forming apparatus according to claim 1,
a preceding sheet passing through the second conveying path after being conveyed as being switched-back by the switch-back conveying portion and a succeeding sheet conveyed through the first conveying path toward the switch-back conveying portion are passed each other with the first conveying path and the second conveying path, in a case that continuing sheets are guided to the first conveying path by the guide portion and are conveyed to the switch-back conveying portion via the first conveying path; and
a preceding sheet passing through the first conveying path after being conveyed as being switched-back by the switch-back conveying portion and a succeeding sheet conveyed through the second conveying path toward the switch-back conveying portion are passed each other at the first conveying path and the second conveying path, in a case that continuing sheets are guided to the second conveying path by the guide portion and are conveyed to the switch-back conveying portion via the second conveying path.

3. The image forming apparatus according to claim 1,
wherein the first conveying path is connected to a discharge portion to discharge a sheet to the outside of the apparatus;
a sheet conveyed as being switched-back by the switch-back conveying portion and passed through the first conveying path is discharged by the discharge portion;
the second conveying path is connected to a re-conveying portion to convey, to the image forming portion anew, a sheet conveyed as being switched-back by the switch-back conveying portion; and
a sheet conveyed as being switched-back by the switch-back conveying portion and passed through the second conveying path is conveyed to the re-conveying portion.

4. The image forming apparatus according to claim 1, further comprising:
a second guide portion which is arranged between the first and second conveying paths and the switch-back conveying portion and which guides a sheet conveyed as being switched-back by the switch-back conveying portion selectively to either the first conveying path or the second conveying path;
wherein the second guide portion guides a sheet passed through the first conveying path and conveyed as being switched-back by the switch-back conveying portion to the second conveying path and guides a sheet passed through the second conveying path and conveyed as being switched-back by the switch-back conveying portion to the first conveying path.

5. The image forming apparatus according to claim 4,
wherein the guide portion and the second guide portion are driven by the same driving source.

6. The image forming apparatus according to claim 1, further comprising:
a first, a second and a third rollers;
wherein a sheet conveyed by the first roller and the second roller passes through the first conveying path; and
a sheet conveyed by the second roller and the third roller passes through the second conveying path.

7. The image forming apparatus according to claim 6, further comprising:
an upstream conveying path which is arranged at an upstream side of the first conveying path and the second conveying path and to which a sheet having an image formed is conveyed; and
a downstream conveying path which is branched from the second conveying path and to which a sheet conveyed as being switched-back is conveyed;
wherein a pair of inlet rollers which is arranged at the upstream conveying path and which conveys a sheet to the first conveying path or the second conveying path and a pair of downstream conveying rollers which is arranged at the downstream conveying path and which conveys a sheet conveyed as being switched-back are driven by the same driving source as the driving source to drive the first to third rollers.
